(19) United States
(12) Patent Application Publication
(10) Pub. No.: US 2007/0097016 A1
(43) Pub. Date: May 3, 2007

(54) Triple Screen Video Arcade Circuit

(75) Inventor: Scott James McGowan, Kirkland, WA (US)

Correspondence Address: Scott McGowan, 12111 NE 149th St.,, Kirkland, WA, 98034, US

(73) Assignee: Scott James McGowan, Kirkland, WA (US)

(21) Appl. No.: 11/163,682

(22) Filed: Oct. 27, 2005

(51) Int. Cl. G09G 5/00

(52) U.S. Cl. 345/1.3

(57) ABSTRACT

Triple Screen Arcade is a video circuitry design that provides a low cost method for creating three video outputs that span a single large video bitmap area. The method uses low cost video controller chips intended for dual screen applications of Laptop PCs (personal computers) combined with an FPGA (field programmable gate array) and other electronic parts. Further a video driver methodology is used to make the process work well in common operating systems. The video product is used for three screen video arcade games, three screen flight simulators and three screen business applications. Three screen spanning using the single large memory map is possible with off-the-shelf high speed gaming and graphics computer programs. All three display data flows are vertically phased locked to reduce eye fatigue and to make frame to frame timing the same for all three displays, thus improving animations that span all three displays.

Triple Screen Arcade Video Circuit combines an off-the-shelf low cost video controller IC with a FPGA (field programmable gate Array) circuit to create a three screen video output circuit. This overall circuit has the features of low production cost (only a modest size FPGA is needed), low development cost (no new custom IC needs be designed), has all three video screen outputs vertically phase locked and has a single video hardware memory map. The three screen phase locking reduces eye fatigue for the viewer and improves frame to frame timing of animation of large multi-screen images, below a few nanoseconds of error. The single hardware memory map allows for off-the-shelf video games and any animating application software to make use of the all three screens of this video display circuit, as no modification to software is needed to accommodate multiple video fame memories.

### DRAWINGS LIST

FIG. 1 Low Cost 3 Screen Arcade with Single Memory Map, shows typical 3 display orientation and representation as one triple wide image area in video memory.

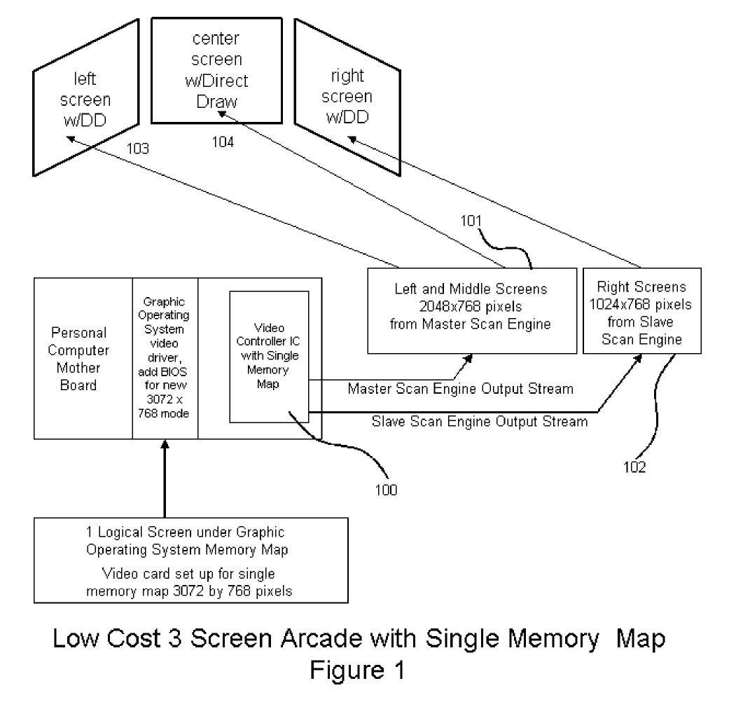

FIG. 2. Circuitry Layout with Functional Description of 3 Display System, how video memory is scanned by the two video engines in the video controller and how the second double-wide image is digitally processed into two normal size video flows.

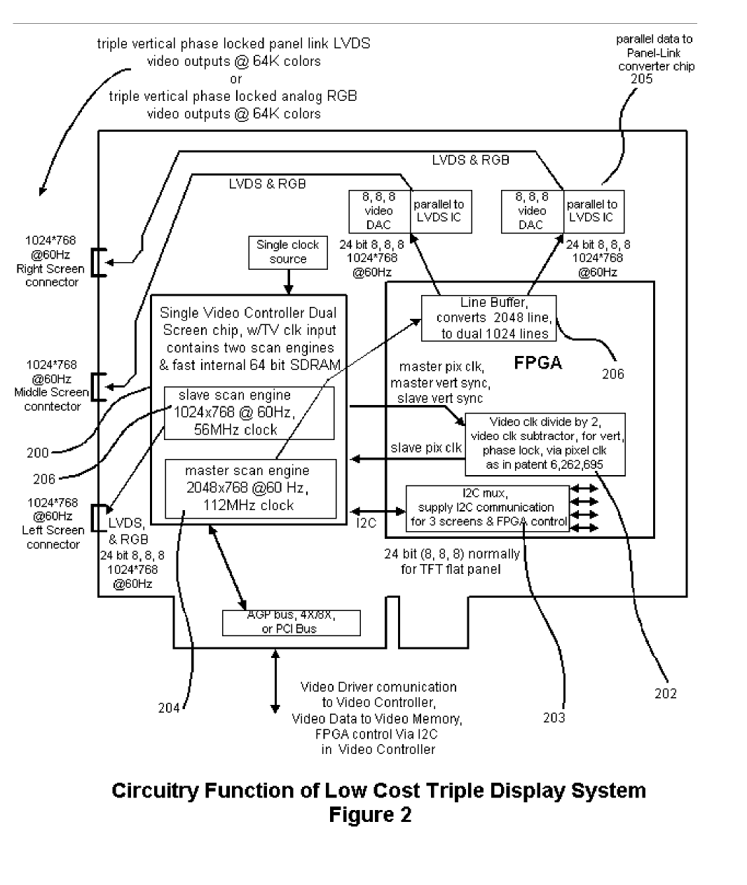

FIG. 3. Faster video data updates (writes and reads) can be done from the computer bus into video memory with this variant of the design, that allows for ½ normal scan speed of the scan engine for the double wide video flow.

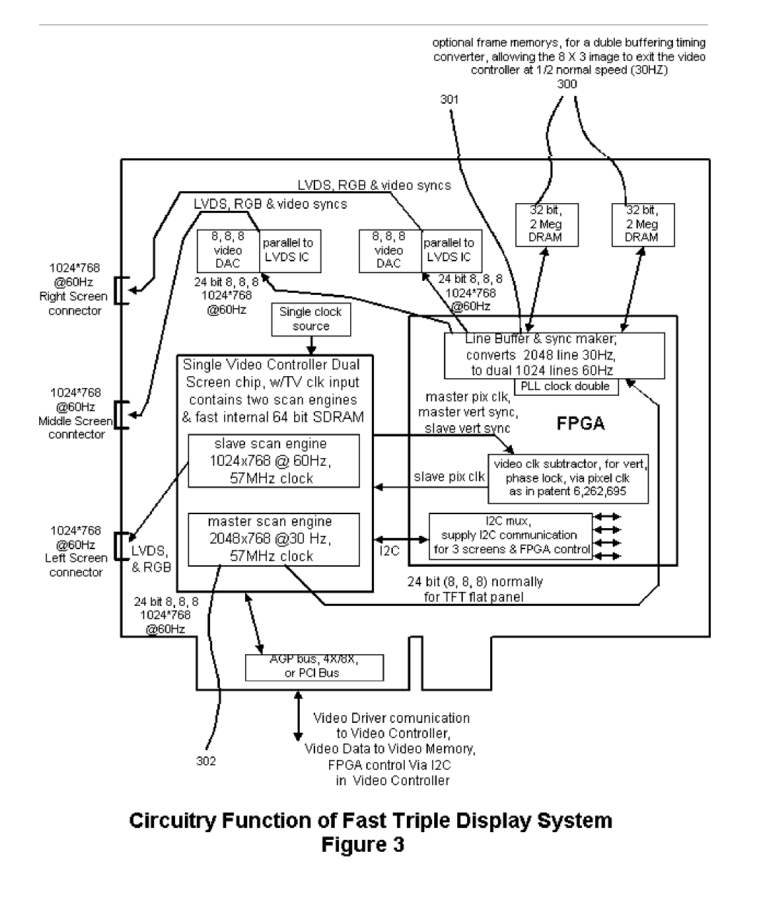

### BACKGROUND OF THE INVENTION

The present invention relates to the use of video controller chips to make more useful display systems with more screens, than had been intended as the feature sets of the video controller chips. Also that the larger number of displays may be vertically and horizontally phase locked. Also that the multiple displays have a single video memory map as perceived by common game software applications, flight simulator software applications and business applications, particularly those that are benefited from multiple windows.

This invention lowers the cost of such products, for cost to the users and cost of development. This invention also adds features not commonly found in uses of the same video controller integrated circuit chips.

### Description of the Prior Art

Prior art typically used multiple video controller chips to create multiple displays. The prior are does not use a double wide second video flow, then split into two normal size flows to increase the number of display screen outputs. The prior art has taken multiple video controllers and copied them onto a single piece of silicon, but they are in function and practice, multiple video controllers. As such the computers using the video designs of that nature do not see the video memory as continuous. Thus 3 or more screen games and other applications must be made custom for those video designs. This reduces product usefulness to the users, and increases costs to the users. Prior art does not use dual scan engine video controllers as a low cost starting point to achieve three screen video systems.

### Description of the Preferred Embodiments

Invention embodies, expand the intended use of Laptop PC video controller chip 100 and 200, that was intended for use in dual screen laptop personal computers, to achieve an additional video output stream to a third screen 101 and 102. Invention embodies a video controller IC and additional digital circuits to split a double-wide image 101 into two smaller images 103 and 104.

The invention uses a single dual output (dual scan engine) video controller 200, that has one scan engine assigned to be the master scan engine that scans 2048 by 768 pixels, 204 and second scan engine assigned to be the slave 201. The master scan engine scans a 8×3 ratio image and outputs its data via a 24 bit parallel bus and that data stream is divided into to data streams by the line buffer in the FPGA 206. Invention embodies circuits that use the same clock rate, thus able to use video clock subtractor (clock subtraction circuit) 202 of U.S. Pat. No. 6,626,695. The slave scan engine, uniquely scanning half the number of pixels as the master scan engine, has its clocks interrupted by the video clock subtractor 202 to achieve vertical and horizontal phase locking of the final display data flows. Invention embodies the multiplexing of the I2C ports 203 on the video controller to provide low cost control of the added digital circuits by the software video driver. Invention embodies the multiplexing of the I2C ports to provide I2C ports for each of the users display screens. Invention embodies the continuous video memory map to provide easy use of software applications that display imagery on all three screens.

Easing of the video memory bandwidth requirement of the video controller IC is done by scanning video memory in the video controller IC at ½ normal scan speed 300. This improves the memory bandwidth remaining for the users video data from his/her computer to be painted into video memory faster. This is done by the added frame memory to the FPGA, so that a whole 30 Hhz frame of 2048 by 762 image can be held for faster scanning by the final output 300.

The recovery of full speed frames to the final video flow is done by the FPGA managing two video memory IC's acting as double buffer frame memories 300. The line buffer 301 in conjunction with the memories converts the 30 Hz output 302 of the master scan engine in the video controller IC to 60 Hz in the final data flow to the user's display monitors. Timing control of the external frame buffer memories 300 is accomplished by using the synchronous feature of SDRAM for the final read scanning, while using 1024 count jumps in memory addressing when writing every other pixel into the memory controlled by the FPGA.

What is claimed is:

1. A novel three screen video design comprising a circuit whereas the dual display right-hand video output scan engine one of the dual scan engine video controller IC is used as a direct scan source for the right-hand screen of this triple display system And the left-hand screen and middle screens obtain scan video flow from the scan engine two of the dual display video controller IC, by using a line buffer in a IC external of the video controller to split a single long line, which is double the normal length, into two scan lines, one for the left-hand display and one for the right hand display.

2. A three screen video design as in claim 1 where as all three video flows to the three screens represent the same resolution per image inch and the first video flow from the video controller IC represents the ⅔ left side of the complete raster image, and the second video flow from the video controller IC represents the right ⅓ of the image raster.

3. A three screen video design as in claim 1 where as a typical laptop PC video controller is used as it has two video flow outputs, and at least one must be a parallel digital video bus, as in laptop PCs use flat panel displays that require a digital, parallel connection and that the laptop digital video output is a convenient starting point to add the double wide image splitting circuits of this invention.

4. A novel video display circuit design comprised of a video controller having two built-in scan engines, whereas the master scan engine in the video controller IC may be run at ½ of the frame rate, as it scans twice as much horizontal pixels, so that the pixel data rate is the same in both scan engines to ease the video memory bandwidth consumption for screen scanning, as the human eye cannot discern image changes in animations, faster than 30 Hz, however the final video output to the CRT screens and or flat panel screens may still be full speed, such as a multiple of the 30 Hz rate, as to be convenient for the scanning standards of CRT's and or flat panel screens.

5. A video display circuit design as in claim 4 comprised of a video controller having two built-in scan engines, whereas the master scan engine in the video controller IC is be run at the final video output frame rate, as it scans twice as much horizontal pixels, so as to further reduce per unit cost manufacture, by requiring a lower cost FPGA that only has a line buffer in it, to break the long video line into two half size lines.

6. A three screen display system as in claim 1 comprised of the first video flow of a 4×3 (horizontal by vertical) ratio image and the second video flow is of an 8×3 image that uses a line buffer digital circuit involving gates and memory FIFO (first in first out buffer) to split the 8×3 ratio video flow into two video flows, each of 4×3 ratio, whereas the combination of the first video flow and the split second video flow now creates 3 final video flows, whereas the first video flow being for the 4×3 left hand screen (screen number 1), next, the left side of the second video 8×3 flow being for the 4×3 middle screen (screen number 2) and the right side of the second video 8×3 flow being for the 4×3 right screen (screen number 3).

7. The three video data flows (3 screens), in a video circuit as in claim 1 become phase locked in both vertical and horizontal timing for improved animations and reduced eye fatigue by use of U.S. Pat. No. 6,262,695 pixel clock “subtractor” circuit as an additional feature/function, whereas the novel concept here is that three vertically phase locked screens occurred from the phase locking of a third video flow, to two video flows that are already phase locked by design, whereas this claim is not novel in-of-itself, but novel in its use in the low cost three screen system, whereas two side-by-side screen data flows from the 8×3 image that are converted to two 4×3 data flows, are phase locked by the conceptual nature of the design, and the third screen data flow is vertically phase locked to the first two.

8. A three screen display flow circuit as in claim 1 whereas the final video data flows, as an additional feature/function, have the same type of connection for ease of use for systems having three similar CRT displays or three similar digital LVDS signal driven displays, whereas, two of the three display data flows are not by nature of the same due to the design starting with a two display laptop video controller integrated circuit.

9. A novel three screen display circuit having as a cost reducing method, uses digital circuits that are external of the video controller chip to multiplex signals from the I2C bus of the video controller chip, providing a seamless low cost method of I2C serial control from the video driver software to additional digital circuits and display monitors, where as no additional connections to a personal computers typical buss' of the PCI and AGP type is needed.
